(19) United States
(12) Patent Application Publication
(10) Pub. No.: US 2020/0044960 A1
(43) Pub. Date: Feb. 6, 2020

(54) NETWORK AUTOMATIC LINK BACKUP METHOD AND NETWORK SYSTEM THEREOF

(71) Applicant: ESTINET TECHNOLOGIES INCORPORATION, Hsinchu City (TW)

(72) Inventors: Ming-Sian Lin, Tainan City (TW); Chih-Che Lin, Hsinchu City (TW)

(21) Appl. No.: 16/454,260

(22) Filed: Jun. 27, 2019

(30) Foreign Application Priority Data
Aug. 3, 2018 (TW) 107127085

(51) Int. Cl. H04L 12/703; H04L 12/24; H04L 12/851; H04L 29/06

(52) U.S. Cl. CPC H04L 45/28; H04L 69/22; H04L 47/24; H04L 41/0668

(57) ABSTRACT

A network automatic link backup method and a network system thereof are provided. The method can be applied to the network system including at least two spine switches. A backup link is established between the two spine switches. When original links fail, a backup mechanism inside the spine switch is performed. In the network system, each of the spine switches has a link failover group. When the spine switch receives packets from a host, the packets are analyzed to determine priority of each link towards the destination. Then the packets can be forwarded through a specific switch port based on the priority. However, when the link for the spine switch to forward the packets fails, in order to complete the transmission, the packets are transmitted to another spine switch via the backup link without the intervention of the software-defined network controller.

### CROSS-REFERENCE TO RELATED PATENT APPLICATION

This application claims the benefit of priority to Taiwan Patent Application No. 107127085, filed on Aug. 3, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a network automatic link backup method, and more particularly to a method and a related network system for achieving the goal of automatic link backup by establishing a backup link between two spine switches in a network.

### BACKGROUND OF THE DISCLOSURE

To construct a network system, one of the most important things is the reliability of network paths. Therefore, various kinds of network topology provide a variety of backup or failover solutions to path failure, so as to complete a failover in a shortest time.

For example, a single-link failover is provided between network switches (network nodes) having only one link to restore a broken link and to set a static rule within network switches. When a communication port or a link is failed, a packet is transmitted through the other specific communication ports. However, such a backup mechanism relies on a switch controller in the network to modify flow rules so that the packet can be transmitted according to new flow rules, and avoid the path having link failure. As a result, the backup time may be longer and the network response time may also be affected by the efficiency of updating the flow rules of the switch.

In a multiple-link failover mechanism with higher costs, two links are established between network nodes, such as network switches, including a spine switch and a leaf switch, connected by two links with each other. However, there is no data link for data transmission between the traditional spine switch sets. Under the above configuration, a network controller, such as a software-defined network controller (SDN controller), can set up packet forwarding rules, the packets are transmitted by spine switches between leaf switches, while the packet forwarding rules can be realized by selecting a forwarding link in the fast-failover group based on the link priority.

That is, when a packet should be forwarded from the leaf switch, according to group rules, to determine a forwarding port connected to the spine switches with a first priority and a second priority. If the first spine switch with the first priority fails, the forwarding port with the second priority can immediately transmit packets to the spine switch with the second priority. That is to say, when a link fails, another link can quickly complete the backup and restore the reachability of the network path.

However, since certain nodes may adopt single link, it is still possible to cause long backup time and low recovery efficiency, so that the backup cannot be achieved comprehensively.

For example, FIG. 1 illustrates a two-tier network structure. The first tier consists of spine switches, including a first spine switch Spine1 and a second spine switch Spine2; and the second tier consists of leaf switches, including a first leaf switch Leaf1, a second leaf switch Leaf2, a third leaf switch Learf3 and a fourth leaf switch Leaf4. This example shows that when a link 101 between Spine2 and Leaf4 fails, if Spine2 receives a packet from Leaf1 through the link 102 and the packet from Leaf1 is destined for Leaf4, the packet from Leaf1 cannot be transmitted to Leaf4. The controller in the network system should avoid the packet from Leaf1 destined for Leaf4 being sent to Spine2, so as to avoid passing through the failed link 101. Similarly, Leaf2 and Leaf3 should avoid sending the packet destined for Leaf4 to Spine2, otherwise Spine2 cannot find an available link to transmit the packet to the destination, Leaf4.

However, in this system, since the leaf switches Leaf1, Leaf2 and Leaf3 cannot detect a disconnection of the link 101 between Spine2 and Leaf4, the packet destined to Leaf4 is still transmitted to Spine2, and thus the packet fails to be transmitted to the destination.

There is no data link between spine switches in a common network since the data link forms a loop in the network topology. Therefore, the conventional network protocol, such as a spanning tree protocol (STP), has a certain chance to block the data link and makes the data link invalid. Even worse, if the spanning tree protocol does not close this link, one data link between a spine switch and a leaf switch will be blocked to avoid a loop. Such a network topology will suffer other problems, e.g., a packet would unnecessarily traverse one more hop to reach the destination node.

In the related art, even though a link may be established between spine switches, the link is mostly used for some protocols to exchange control information. For example, a multi-chassis link aggregation (MCLAG) protocol would use such a link to do spine switch backup. However, an MCLAG protocol requires each spine switch to run a complicated MCLAG protocol entity to compute routes in a distributed manner and requires each leaf switch to run a link aggregation protocol to work with the MCLAG protocol. This approach has high complexity and requires an administrator to set up configuration manually, which is time-consuming and prone to cause errors.

### SUMMARY OF THE DISCLOSURE

In response to the above-referenced technical inadequacies, the present disclosure provides a network automatic link backup method and a network system thereof.

In one aspect, the present disclosure provides a network automatic link backup method operating in a network system configured with a plurality of spine switches. Each spine switch is equipped with a link failover group and forwarding paths for each terminal device in the network system. The method includes: receiving, by a first spine switch of the plurality of spine switches, a packet generated by the terminal device, wherein a backup link is established between the first spine switch and a second spine switch; parsing the packet to conclude a link order, matching the forwarding packet to a destination in the link failover group; transmitting the packet according to priority of multiple communication ports in the link order, wherein the method determines whether an active link or an active communication port that is connected to the destination for the packet is valid; if the active link or the active communication port fails, the first spine switch selects a link having next highest priority to forward according to the link priorities in the corresponding link failover group; if no link of other spine switches can be used to forward the packet, the first spine switch uses the backup link between the first spine switch and the second spine switch to transmit the packet to the second spine switch, the packet is parsed by the second spine switch, and then the packet is transmitted according to the link order matching the forwarding packet to the destination in the link failover group in the second spine switch to forward the packet; if one link is valid, the forwarding is completed based on the link order derived from the corresponding link failover group in the second spine switch.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 illustrates a schematic diagram of a network architecture in the related art;

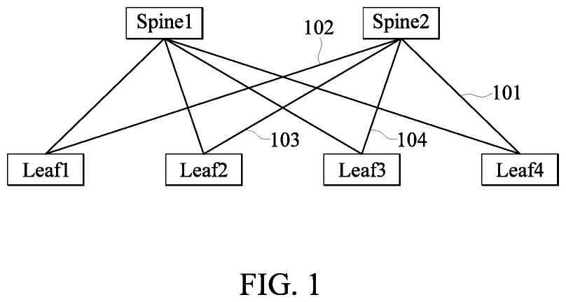

FIG. 2 illustrates a schematic diagram of a basic network architecture in a network system according to an embodiment the present disclosure;

FIG. 3 illustrates a flowchart of an initialization of the network system according to an embodiment of the present disclosure;

FIG. 4 illustrates a flowchart of a network automatic link backup method according to an embodiment of the present disclosure;

FIG. 5 illustrates a schematic diagram of a network system implementing the network automatic link backup method according to an embodiment of the present disclosure;

FIG. 6 illustrates a schematic diagram of the network system implementing the network automatic link backup method according to an embodiment of the present disclosure; and

FIG. 7 illustrates a schematic diagram of implementing fast transmission of a large number of failover packets using a link failover group according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In a network automatic link backup method and a network system thereof disclosed in the present disclosure, a plurality of switches in the network system can be classified into two types of switches according to functions: a spine switch (also known as an aggregate switch) and a leaf switch (also known as an edge switch). At least two spine switches and the plurality of leaf switches are configured in the network system. If the method is applicable to a software-defined network (SDN), a software-defined network controller (hereinafter referred to as an SDN controller) that runs a program for an automatic backup process in the network system is included. The procedures to implement the network automatic link backup method include setting up a spine backup link between the spine switches. This network system includes two different types of links, namely, the backup link between the spine switches and an active data link between the spine switch and the leaf switch. The category of a link can be automatically distinguished as a backup link or an active data link according to the attributes of the connected switches.

The network automatic link backup method proposed in the present disclosure is applicable to the software-defined network, and a centralized controller (i.e., the SDN controller) used in this software-defined network that can realize an optimization of topology and a better path planning, etc. An OpenFlow protocol allows the SDN controller and SDN switches to communicate with each other using a standardized and open message format, so that the controller can instruct an SDN switch to transmit information or capture packets to the controller. The SDN switch uses a flow table to control the forwarding operation of a packet. Such operation for a packet in a switch is also called the data plane of a switch. On the data plane, the SDN switch uses the flow table to determine to which communication port the received packet should be forwarded, or to perform other actions associated with the flow entry that a packet matches. Therefore, a network administrator can use the SDN controller to compose the flow table of an SDN switch to further compose or optimize the desired network routing functions or network monitoring functions so as to establish a satisfied network system.

Currently, a data center would use an SDN architecture for operation. The concept of SDN separates the data plane of a network from the control plane of a network. SDN uses a centralized controller to replace the conventional distributed network protocol in the network control plane. With SDN, the switches only need to handle the data plane of the network. Also, the centralized controller is helpful to optimize network operations.

Switches running the OpenFlow protocol, such as the SDN switches, firstly establish a logic control connection with controllers running the OpenFlow protocol, such as the SDN controllers. Then the SDN controller distributes entries of flow tables to the SDN switches through the established logic control connections. Then, when a packet arrives at an SDN switch, the SDN switch uses the flow table to lookup if there is a matched flow entry for the incoming packet and performs corresponding actions (such as packet forwarding) according to the rules of the matched flow entries.

After a switch is connected with the SDN controller, traffic is allowed to transmit to the other terminal device via the switch. When receiving a new packet, the switch looks up its flow table in the memory. If there is a matched flow entry in the flow table, the switch performs the action of the flow entry, and updates a statistical value of the flow entry in the flow table. If there is no matched flow entry in the flow table, the switch generates a message of “packet-in” with received content and transmits the message packet to the SDN controller. The SDN controller updates its control logics and then generates a “flow-mod” message or a “packet-out” message. It then transmits the message to the switch so that the switch adds the new flow entry based on the received message. Since subsequent related packets match this new flow entry, there is no need to generate the “packet-in” message again to the SDN controller for processing. Under this architecture, the central processing unit of the switch will not be busy to process subsequent packets belong to the same flow.

However, in an SDN system that does not have a backup link between spine switches, the link backup would be achieved by modifying the data flow entries in the flow table of switches. This operation needs intervention of the SDN controller, when a link fails, such as a disconnection or a communication port failure on a link.

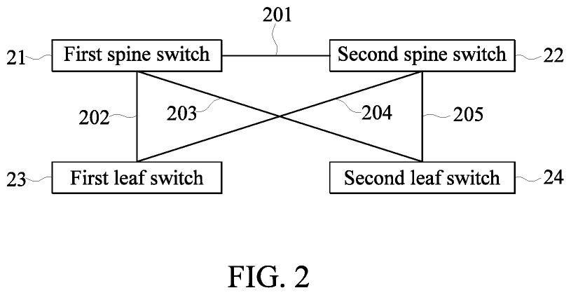

The network automatic link backup method can be applied to various types of network systems, a data center or a general network connection. A relevant network system such as a two-tier network system is shown as FIG. 2, which illustrates a schematic diagram of a basic network architecture in a network system. The two-tier network can be implemented as the above software-defined network. The two-tier network includes two spine switches: the first spine switch 21 and the second spine switch 22, and two leaf switches: the first leaf switch 23 and the second leaf switch 24. The first spine switch 21 and the second spine switch 22 have links (202, 203, 204 and 205) with each leaf switch (23, 24) respectively. According to attributes of the switches, namely, the switch identifiers (switch IDs), links 202, 203, 204 and 205 can be determined as active data links.

According to the embodiment of the network system proposed in the present disclosure, the link 201 is further established between the first spine switch 21 and the second spine switch 22. Based on the attributes of the switches on the both sides of a link, it can be known that the link 201 is a backup link (a backup link 201) connected to two spine switches.

The two-tier network is an embodiment of an SDN, including at least two spine switches, at least two leaf switches and at least one SDN controller (not shown in the drawings). The spine switch in this two-tier network system can be used as a backbone switch for the network and can be connected to another network, such as the Internet. At least two leaf switches can be used as terminal networking devices or device for connection, and data links are established between each leaf switch and spine switch. According to the above embodiment, a backup link established between the spine switches 21 and 22 can be described as a spine backup link (SBL).

The two-tier network system is configured with the at least two spine switches, at least two leaf switches and at least one software-defined network controller. Each switch in the two-tier network system is identified by a switch identifier (switch ID); and each communication port in each switch has a communication port number; attributes of links between each other with link numbers are also defined based on the switch identifier and the communication port number of the link terminal, including the backup link or the active data link. The attributes include backup links and active data links.

The network system proposed by the present disclosure identifies links for each other by the initialization, and establishes a link failover group that contains a backup link between the spine switches. The link failover group is a set of available links established in each switch for each terminal device (or host) route, which implements a concept of the fast failover group in the network system.

According to an embodiment, the underlying technology for establishing this fast failover group on a switch is the OpenFlow protocol, which defines how a network device can be programmed to implement SDN, in order to achieve an abstraction of network control. OpenFlow protocol defines the group table for packet lookup and forwarding. The group table contains multiple group entries, and a group entry can include a list of an action bucket. Multiple action buckets in this list are sequential, and each action bucket contains a set of multiple execution actions. Similar to the flow table, the group table includes multiple group entries. The flow entry in the flow table within each SDN switch indicates a group. When a packet is sent to a specified group after rule comparison, one or more actions corresponding to the action bucket of a matched flow entry will be performed. For example, when receiving a new packet, the switch looks up a flow table in the memory. If there is a matched flow entry in the flow table, the switch performs the action of the flow entry, such as linking to a group table, and then the packet is transmitted according to the priority of communication ports set by the group entry in the group table.

The action buckets and their actions containing usable data links will be put into a group entry in the group table. The rule of putting these data links into an action bucket of a group entry includes: an active data link is put into the action bucket from front to back, and the backup link is put into the action bucket from back to front.

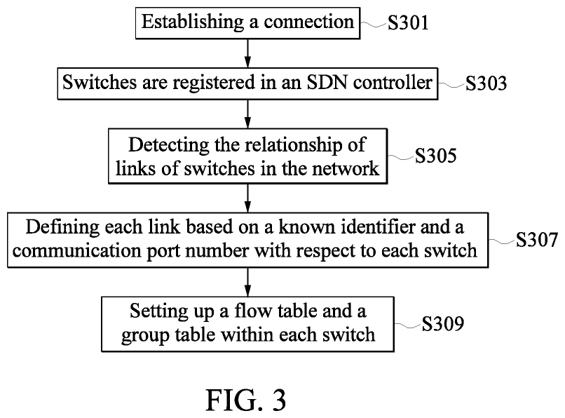

When the related network system operates, the network system initialization is performed firstly. FIG. 3 illustrates a flowchart of an initialization process of the network system according to an embodiment of the present disclosure.

In step S301, the SDN controller and the SDN switches in the network system firstly establish a logic control connection between the controller and the switch. Then, according to the embodiment of the SDN, such as step S303, all switches in the network system need to register to the SDN controller using the switch identifier (switch ID) of each respective switch. In step S305, the SDN controller begins to detect the relationship of links between switches in the network by using each known switch identifier and each switch communication port number to define the switch. As described in step S307, the link between switches is defined by the identifier of the terminal switch of each link and the communication port number. The relationship of links includes a backup link between the spine switches, as well as active data links between the leaf switches and different spine switches.

After that, as described in step S309, the data flow table is set up within the switch, the link failover group is established for each terminal device, and the switches look up flow table to determine how to perform the packet forwarding. The link failover group such as the aforementioned fast failover group, sets the link order for each switch to forward packets, and the link failover group includes: one or more switch identifiers, one or more communication port numbers and a link order of the backup link between spine switches.

It is worth mentioning that when implementing the network automatic link backup method, the SDN controller in the SDN system does not need to intervene in the whole backup process for the change of used link. That is, the method differs from the SDNs in the known technology. When a link disconnects or fails, the SDN controller needs to intervene and reset the routing for each switch in those currently-existing SDNs, which uses only a single link between any two of the switches.

When the network system is in normal operation, a spine switch and a leaf switch transmit data packets through one active data link. When a link failure occurs, such as a disconnection or switch communication port failures, the switch can automatically select the next available active data link recorded in the action bucket in the group for performing packet forwarding based on the behavior defined by the link failover group or the equivalent behavior defined by the switch functions to achieve the purpose of the backup.

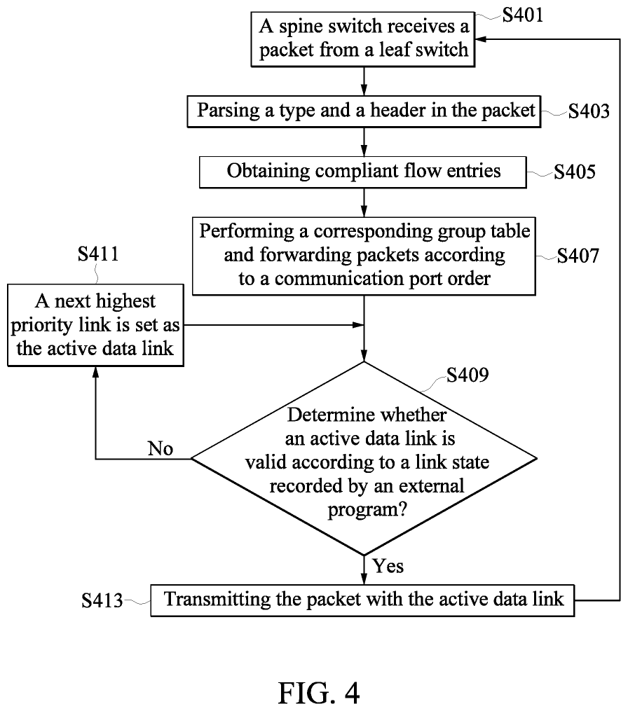

FIG. 4 illustrates a flowchart of a network automatic link backup method applied in a network system including at least two spine switches.

In a general network operation, in step S401, the spine switch receives a packet transmitted from terminal device, and the transmission process can also be transmitted to the spine switch via the leaf switch. In the two-tier network system, at least one of two spine switches, such as a first spine switch, receives packets transmitted from the leaf switch, and a backup link is available between at least two spine switches. After receiving the packet, the first spine switch begins to parse the type and header of the packet (step S403). Then one or more flow entries that match or are compatible are obtained, and a corresponding group table is performed (step S405). A link order in the link failover group is obtained to determine which link is used to transmit the packet. The actions in the flow entry includes but are not limited to forwarding the packet to a destination, and forwarding the packet according to the priority of communication ports (step S407).

Again, as in step S409, the switch monitors the state of each communication port and link (valid or invalid) to determine whether an active data link is valid or not. If an active link is valid (yes), step S413 is performed, and the packet is transmitted over the active link. On the contrary, when the current active link fails (no), according to the link order, such as step S411, the next highest priority link is set to new current active data link. Then, steps S409 is performed to continuously determine whether any one of active links is effective according to the record of the link state.

In this example, if the link or communication port of the first spine switch to the destination (which can pass through another leaf switch) does not fail (no), the packet forwarding is completed. The method returns to step S401 to continue the next step of packet forwarding. If a failure of a related link or a communication port occurs (yes), such as in step S413, the packet is transmitted with the next highest priority link in the two tier network.

One of ways in which the spine switch obtains the state of a communication port and a link is that the software program operating in the switch uses an electric signal of hardware to detect or to timely send a confirmation packet to obtain the state of the communication port and the link, so as to form the spine switch to detect entries of each communication port to determine whether the link connected to the destination is invalid or not.

In the above step S413, in particular, when the failed connection is the active data link between the first spine switch and a leaf switch leading to the destination, the system will use the next available link in the entry of the group table. At this point, if the first spine switch finds that there is no link in the downlink communication port to reach the specified destination of the packet, since a spine backup link has been placed in the link failover group with the lowest priority, the downlink communication port on the first spine switch itself cannot send the packet to the next hop leading to the destination. The first spine switch transmits the packet to the second spine switch using the backup link. The packet is then parsed by the second spine switch with the same lookup process. The packet is then transmitted to the destination via an active link recorded in the link failover group in the second spine switch, and the packet can be forwarded to a leaf switch connected to the second spine switch and finally reach the destination specified in the header in the packet.

It is worth mentioning that when there is a link failure in the network system, aside from using a mechanism of the link failover group to implement the link failover in real-time, the mechanism of the link failover group can quickly recover the original state without the intervention of the network controller (such as a SDN controller) or manual intervention.

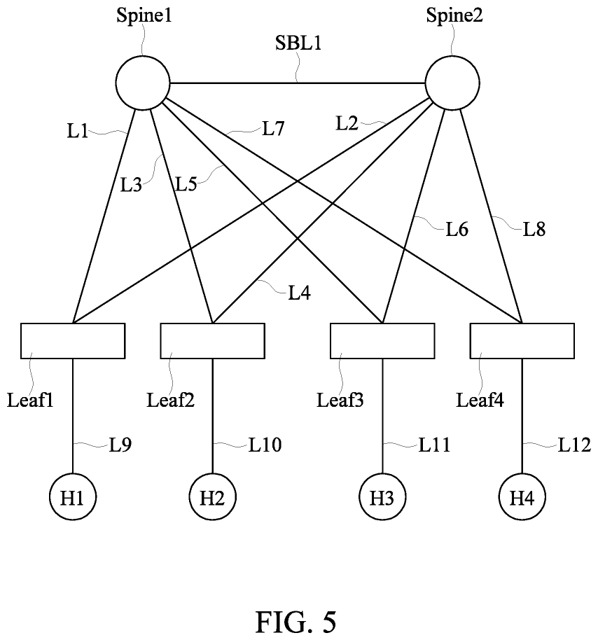

FIG. 5 illustrates a schematic diagram of a network automatic link backup method according to an embodiment of the present disclosure.

When the network system is enabled, according to the role of the switch defined by the manager in the embodiment of the network automatic link backup method illustrated in the drawings, the spine switch such as the first spine switch Spine1 and the second spine switch Spine2, and the leaf switch such as the first leaf switch Leaf1, the second leaf switch Leaf2, the third leaf switch Leaf3 and the fourth leaf switch Leaf4; and two types of links, such as the backup link and the active data link are detected. As shown in FIG. 5, a first backup link SBL1 between Spine1 and Spine2, and the active data links L1, L2, L3, L4, L5, L6, L7, L8, L9, L10, L11 and L12 associated with Leaf1, Leaf2, Leaf3 and Leaf4, the above exemplary links for each leaf switch establish at least one active data link with Spine1 and Spine2 respectively.

In this embodiment, the terminal devices H1, H2, H3 and H4 connected to Leaf1, Leaf2, Leaf3 and Leaf4, respectively establish a link failover group by the network system. The link failover group belonged to the terminal devices includes multiple group entries such as Table I, wherein a source, a destination, a switch identifier and a link number are recorded in multiple group entries, and each link number respectively corresponds to the communication port number of respective switch in the terminal. In this example, Table I describes an application of the link of packet forwarding between terminal devices H1 and H4. The link failover group belonging to each terminal device can be used independently or shared with other terminal device in the same network system. This way, however, the path conflict may occur and needs to be resolved by the controller. Thus, the administrator needs to carefully design the link failover group in this case.

For example, an SDN controller can set up packet forwarding rules of the switch through the link failover group, set up a packet that matches certain criteria, such as a destination, handle and forward the packet according to group rules, set forwarding communication ports by the group and decide which communication port to forward packets. When setting the forwarding communication ports, the priority of the forwarding port is set in the group. For example, when the link of the first priority communication port fails, the packet is forwarded by the second priority communication port. When the first and second priority communication ports fail, the packet is forwarded by the third priority communication port.

TABLE I

| | | | Contents in the |
|---|---|---|---|
| Source | Destination | Switch | link failover group |
| H1 | H4 | Leaf1 | L1, L2 |
| | | Leaf4 | L12 |
| | | Spine1 | L7, SBL1 |
| | | Spine2 | L8, SBL1 |
| H4 | H1 | Leaf1 | L9 |
| | | Leaf4 | L7, L8 |
| | | Spine1 | L1, SBL1 |
| | | Spine2 | L2, SBL1 |

According to the embodiment of the link failover group recited in Table I, the link number (link ID) is used to represent the selection of the communication port for the switch transmitting packets, and the link number can also correspond to the communication port number of the switch.

According to the example shown in Table I and FIG. 5, in a general operating condition, the terminal device H1 (source) would forward the packet through the active data link L9 to the terminal device H4 (destination). The packet is firstly passed through Leaf1 according to the setting of the link failover group. The packet is sent along the active data link L1 as shown in the link failover group. When the packet arrives at Spine1, the order of link to the terminal device H4 in the link failover group is queried. This example shows the selection of the active data link L7 to transmit. The packet arrives at Leaf4, then is passed through the active data link L12, and finally is transmitted to the destination of the terminal device H4.

On the contrary, if the terminal device H4 transmits a packet to the destination terminal device H1, under normal condition, the order of link for packet forwarding is L12, Leaf4, L7, Spine1, L1, Leaf1 and L9 sequentially.

In an abnormal state, when the link L7 fails, according to the records of the link failover group, the packet from the terminal device H1 is transmitted to the terminal device H4 through the link L9, Leaf1 and the link L1 and then reaches Spine1. The corresponding second priority is SBL1 between two spine switches (Spine1 and Spine2), which transmits the packet to Spine2. The packet is forwarded to Leaf4 from the active data link L8 connected to Spine2, and the packet finally reaches the destination of the terminal device H4. The backup link order is L9, Leaf1, L1, Spine1, SBL1, Spine2, L8, Leaf4 and L12 sequentially. If there is a packet sent back from the terminal device H4 to the terminal device H1, it is also possible to send the packet back from this path.

Thus, when the active data link L7 fails, the first backup link SBL1 between the spine switches (Spine1 and Spine2) completes the backup through the settings of the link failover group. Otherwise Spine1 in the original packet transmission route may choose to discard the packet according to the protocol since there is no path to reach the destination due to the failure of the link L7. The backup mechanism also eliminates a longer interrupt time required for the SDN controller to intervene in the re-computing path in the SDN system.

Aside from the network system of two spine switches described in the above embodiments, the network automatic link backup method, can be applied in a network system with three or more spine switches, and the plurality of spine switches form a chain network, a ring network, a mesh network or other types of network topologies. In the system of various network topologies, the spine switch will achieve the purpose of network automatic link backup by establishing mutual backup link accompanying with the link failover group providing the spine switch without generating a loop.

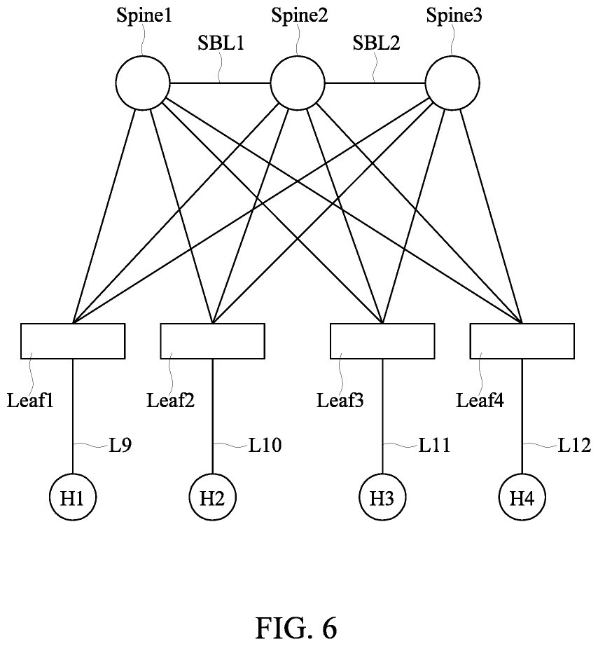

Please refer to FIG. 6, which illustrates a schematic diagram of the network automatic link backup method according to an embodiment of the present disclosure. The network system includes three spine switches. The first backup link SBL1 is established between Spine1 and Spine2, and SBL2 is established between SBL2 and Spine3. Each of leaf switches (Leaf1, Leaf2, Leaf3 and Leaf4) is connected to each spine switch (Spine1, Spine2 and Spine3), respectively, with the active data links, and each of leaf switches serves the terminal device. In such a connection, there is a need to avoid the problem of broadcasting packets generated by network loops between spine switches. The problem can be conquered by the use of chain topology so as to cooperate with the design of the using order of the backup path, that is, through the mechanism of the aforementioned the link failover group. Another way to avoid loops causing broadcasting packets is that each spine switch is able to use the backup link between the spine switches once at a time; if the packet fails to be forwarded after the use of the backup link, the packet is required to be processed by a controller.

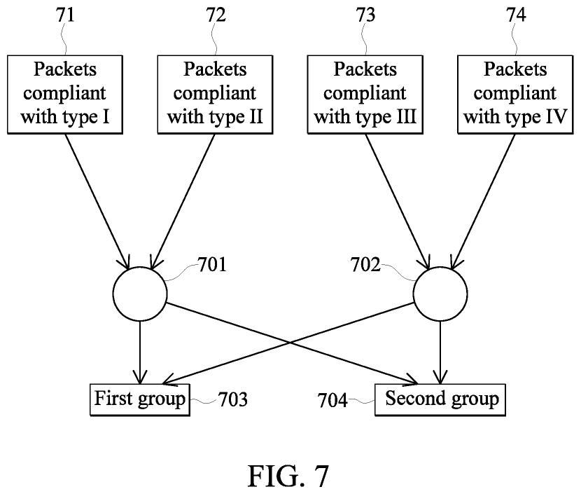

Please refer to FIG. 7, which illustrates a schematic diagram of implementing fast transmission of a large number of failover packets using a link failover group according to an embodiment of the present disclosure. The link failover group used to set up each terminal device can be shared.

Each of these leaf switches is first represented by a virtual communication port, and each virtual communication port is provided with a forwarding port collection. For example, a first virtual communication Port 701 has a forwarding port collection, and the second virtual communication Port 702 has a forwarding port collection. The system determines the priority of the forwarding port according to the possible arrangement of the forwarding port collection, and the priority is set in the contents of link failover group in which the priority belongs and is shared. For example, a first group 703 has forwarding ports with the order 1 to 2 (backup ports), and a second group 704 has forwarding ports with the order 2 to 1 (backup ports). In this way, the system can set up a fast failover group according to different arrangement, so that the packets transmitted between terminal devices can be forwarded by sharing the fast failover group for backup purposes.

In operation, when a link fails and the fast transmission of a large number of failover packets should be performed, the packets can be distinguished as packets compliant with type I packet 71, packets compliant with type II packet 72, packets compliant with type III packet 73, and packets compliant with type IV packet 74. One can respectively set the first virtual communication port 701 and the second virtual communication Port 702 of different virtualized leaf switches to forward, and to forward in the order of the forwarding ports of a first group 703 and a second group 704 in the link failover group.

To sum up, according to the network automatic link backup method and a network system thereof, a backup link is established between the network spine switches, and only one single link is needed, without multiple-link failover spending relatively higher costs. When the spine switch is aware of a connection failure, which is directed to the destination leaf switch of the packet by an electric signal of hardware or a confirmation packet, the packet is transmitted through the next highest priority connection in accordance with the priority of the communication port of the link failover group. For example, using the next highest priority of link number or selecting next communication port can achieve the purpose of backup without operations of the network controller.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A network automatic link backup method, operating in a network system configured with a plurality of spine switches and each spine switch equipped with a link failover group and forwarding paths for each terminal device in the network system, the method comprising:
receiving, by a first spine switch of the plurality of spine switches, a packet generated by the terminal device, wherein a backup link is established between the first spine switch and a second spine switch;
parsing the packet to conclude a link order, matching the forwarding of the packet to a destination in the link failover group; and
transmitting the packet according to priority of multiple communication ports in the link order,
wherein the method determines whether an active link or an active communication port that is connected to the destination for the packet is valid or not; if the active link or the active communication port fails, the first spine switch selects a link having next highest priority to forward according to priority of the link failover group;
if no link of other spine switches can be used to forward the packet, the first spine switch uses the backup link between the first spine switch and the second spine switch to transmit the packet to the second spine switch, the packet is parsed by the second spine switch, and then the packet is transmitted according to the link order matching the forwarding of the packet to the destination in the link failover group in the second spine switch to forward the packet;
if one link is valid, the forwarding is completed based on the link order derived from the second spine switch.

2. The method as claimed in claim 1, wherein the network system is a two-tier network system.

3. The method as claimed in claim 1, wherein each spine switch sets, by using the link failover group, the link order for forwarding the packets for each spine switch, and the link failover group includes: one or more switch identifiers, one or more communication port numbers and a link order of the backup link between spine switches.

4. The method as claimed in claim 3, wherein the link between spine switches in the network system is defined as the backup link or an active data link between the spine switches by using the switch identifiers of each link terminal.

5. The method as claimed in claim 4, wherein the network system is a two-tier network system.

6. The method as claimed in claim 4, wherein the link failover group in each spine switch includes multiple group entries, wherein a source, a destination, the switch identifier and a link number are recorded, wherein each link number respectively corresponds to the communication port number of each spine switch.

7. The method as claimed in claim 1, wherein based on state of each communication port detected by the first spine switch, the method determines whether the link connected to the destination for the packet is invalid.

8. The method as claimed in claim 7, wherein the terminal device transmits the packet to the first spine switch through the first spine switch; and the first spine switch uses the link to forward the packet to the destination through a leaf switch.

9. The method as claimed in claim 8, wherein the network system is a two-tier network system.

10. A network system, comprising:
a plurality of spine switches, including a first spine switch and a second spine switch, and a backup link established between the first spine switch and the second spine switch; and
a plurality of leaf switches, each leaf switch establishing an active data link with each of the plurality of spine switches respectively, wherein each spine switch is equipped with a link failover group for each terminal device in the network system and operates a network automatic link backup method including:
receiving, by a first spine switch, a packet generated by a terminal device; and
parsing the packet to conclude a link order, matching the forwarding of the packet to a destination in the link failover group,
wherein the method determines whether an active link or an active communication port that is connected to the destination for the packet is invalid; if the active link or the active communication port fails, the first spine switch selects a link having next highest priority to forward according to the priority of the link failover group; if no link of other spine switches can be used to forward the packet, the first spine switch uses the backup link between the first spine switch and the second spine switch to transmit the packet to the second spine switch, the packet is parsed by the second spine switch; if one link is valid, the forwarding is completed based on the link order derived from the second spine switch.

11. The network system as claimed in claim 10, wherein the network system is a two-tier network system.

12. The network system as claimed in claim 10, wherein each spine switch sets the link order for forwarding packets for each switch by using the link failover group, and the link failover group includes: one or more switch identifiers, one or more communication port numbers and a link order of the backup link between spine switches.

13. The network system as claimed in claim 12, wherein the link failover group in each switch includes, multiple group entries, wherein a source, a destination, the switch identifier and a link number are recorded, wherein each link number respectively corresponds to the communication port number of each switch.

14. The network system as claimed in claim 13, wherein the network system is a two-tier network system.

15. The network system as claimed in claim 10, wherein each leaf switch in the network system is represented by a virtual communication port, the virtual communication port is configured with a collection of forwarding ports, the network system determines the priority of the forwarding ports according to possible arrangements and the priority is set in the link failover group in each leaf switch.

16. The network system as claimed in claim 15, wherein the network system determines the priority of the forwarding ports through different link orders in the link failover group within each switch and the link failover group includes a backup port.

17. The network system as claimed in claim 16, wherein the network system is a two-tier network system.

18. The network system as claimed in claim 17, wherein the two-tier network system is an SDN with an SDN controller.

19. The network system as claimed in claim 17, wherein the plurality of spine switches form a chain network, a ring network, or a mesh network.
